(19) United States
(12) Patent Application Publication
(10) Pub. No.: US 2019/0155608 A1
(43) Pub. Date: May 23, 2019

(54) FAST PIPELINE RESTART IN PROCESSOR WITH DECOUPLED FETCHER

(71) Applicant: QUALCOMM Incorporated, San Diego, CA (US)

(72) Inventors: Arthur PERAIS, Raleigh, NC (US); Michael Scott MCILVAINE, Raleigh, NC (US); Rami Mohammad A. AL SHEIKH, Morrisville, NC (US); Robert Douglas CLANCY, Cary, NC (US); Luke YEN, Redmond, WA (US); Rodney Wayne SMITH, Raleigh, NC (US)

(21) Appl. No.: 16/193,935

(22) Filed: Nov. 16, 2018

Related U.S. Application Data
(60) Provisional application No. 62/588,283, filed on Nov. 17, 2017.

(51) Int. Cl. G06F 9/38; G06F 9/30; G06F 12/0875

(52) U.S. Cl. CPC G06F 9/3806; G06F 2212/452; G06F 12/0875; G06F 9/30058

(57) ABSTRACT

Aspects of the present disclosure include a method, a device, and a computer-readable medium for restarting an instruction pipeline of a processor that includes a decoupled fetcher. A method comprises detecting, in a processor, a re-fetch event, wherein the processor includes an instruction unit (IU) configured to fetch instructions from a decoupled fetcher (DCF), and simultaneously flushing the IU and the DCF in response to detecting of the re-fetch event.

### CROSS-REFERENCE TO RELATED APPLICATION

The present Application for Patent claims the benefit of U.S. Provisional Patent Application No. 62/588,283, entitled “FAST PIPELINE RESTART IN PROCESSOR WITH DECOUPLED FETCHER,” filed Nov. 17, 2017, pending, assigned to the assignee hereof, and hereby expressly incorporated herein by reference in its entirety.

### INTRODUCTION

Disclosed aspects relate to the restart of an instruction pipeline included in a microprocessor. More particularly, some aspects are directed to the restart of the instruction pipeline of a processor that includes a decoupled fetcher.

Conditional execution of instructions is a conventional feature of processing systems. An example is a conditional instruction, such as a conditional branch instruction, where the direction taken by the conditional branch instruction may depend on how a condition gets resolved. For example, a conditional branch instruction may be represented as, “if <condition1> jump1),” wherein, if condition) evaluates to true, then operational flow of instruction execution jumps to a target address specified by the jump1 label (this scenario may also be referred to as the branch instruction (jump1) being “taken”). On the other hand, if condition1 evaluates to false, then the operational flow may continue to execute the next sequential instruction after the conditional branch instruction, without jumping to the target address. This scenario is also referred to as the branch instruction not being taken, or being “not-taken”. Under certain instruction set architectures (ISAs), instructions other than branch instructions may be conditional, where the behavior of the instruction would be dependent on the related condition.

In general, the manner in which the condition of a conditional instruction will be resolved will be unknown until the conditional instruction is executed. Waiting until the conditional instruction is executed to determine the condition can impose undesirable delays in modern processors which are configured for parallel and out-of-order execution. The delays are particularly disruptive in the case of conditional branch instructions, because the direction in which the branch instruction gets resolved will determine the operational flow of instructions which follow the branch instruction.

In order to improve instruction level parallelism (ILP) and minimize delays, modern processors may include mechanisms to predict the resolution of the condition of conditional instructions prior to their execution. For example, branch prediction mechanisms are implemented to predict whether the direction of the conditional branch instruction will be taken or not-taken before the conditional branch instruction is executed. If the prediction turns out to be erroneous, the instructions which were incorrectly executed based on the incorrect prediction will be flushed. This results in a penalty known as the branch misprediction penalty. If the prediction turns out to be correct, then no branch misprediction penalty is encountered.

Branch prediction mechanisms may be static or dynamic. Branch prediction itself adds latency to a pipeline, otherwise known as the branch prediction penalty. When an instruction is fetched from an instruction cache and processed in an instruction pipeline, branch prediction mechanisms must determine whether the instruction that is fetched is a conditional instruction and whether it is a branch instruction and then make a prediction on the likely direction of the conditional branch instruction. It is desirable to minimize stalls or bubbles related to the process of branch prediction in an instruction execution pipeline. Therefore, branch prediction mechanisms strive to make a prediction as early in an instruction pipeline as possible.

In the pursuit of instruction-level parallelism, significant demands are placed on a processor's instruction delivery mechanism. Delivering the performance necessary to meet future processor execution targets requires that the performance of the instruction delivery mechanism scale with the execution core. Attaining these targets is a challenging task due to I-cache misses, branch mispredictions, and taken branches in the instruction stream. To counter these challenges, some architectures decouple the branch predictor from the instruction fetch unit. A Fetch Target Queue (FTQ) is inserted between the branch predictor and instruction cache. This allows the branch predictor to run far in advance of the address currently being fetched by the cache. The decoupling enables a number of architecture optimizations, including multilevel branch predictor design, fetch-directed instruction prefetching, and easier pipelining of the instruction cache.

For example, some modern microprocessors may decouple instruction fetching from fetch address generation (including branch prediction), allowing fetch address generation to run-ahead and enqueue many future fetch addresses in a decoupling queue (e.g., FTQ). By scanning this queue, prefetch requests can be issued to bring instructions that will be used soon in the instruction cache, improving performance. However, this lengthens the pipeline and increases the pipeline restart latency (e.g., after a branch misprediction), as any fetch address must go through the address generation (a.k.a. Decoupled Fetcher, or DCF stages before going through the Instruction Unit (IU) stages). This restart latency may be a contributor to performance degradation.

### SUMMARY

The following summary is an overview provided solely to aid in the description of various aspects of the disclosure and is provided solely for illustration of the aspects and not limitation thereof.

In accordance with aspects of the disclosure, a method is provided. The method may comprise detecting, in a processor, a re-fetch event, wherein the processor includes an instruction unit (IU) configured to fetch instructions from a decoupled fetcher (DCF) and simultaneously flushing the IU and the DCF in response to detecting of the re-fetch event.

In accordance with other aspects of the disclosure, an apparatus is provided. The apparatus may comprise a processor that includes an instruction unit (IU) configured to fetch instructions from a decoupled fetcher (DCF). The processor may be configured to detect a re-fetch event and simultaneously flush the DCF and the IU in response to detecting of the re-fetch event.

In accordance with yet other aspects of the disclosure, another apparatus is provided. The apparatus may comprise means for detecting a re-fetch event and means for simultaneously flushing an instruction unit (IU) and a decoupled fetcher (DCF) in response to detecting of the re-fetch event.

In accordance with yet other aspects of the disclosure, a non-transitory computer-readable medium is provided. The non-transitory computer-readable medium may comprise at least one instruction for causing a processor to perform operations, comprising code for detecting a re-fetch event and code for simultaneously flushing an instruction unit (IU) and a decoupled fetcher (DCF) in response to detecting of the re-fetch event.

### BRIEF DESCRIPTION OF THE DRAWINGS

The accompanying drawings are presented to aid in the description of aspects of the invention and are provided solely for illustration of the aspects and not limitation thereof.

FIG. 1A illustrates a schematic of a micro-architecture of a processing system that includes a conventional decoupled fetcher.

FIG. 1B illustrates an example branch target buffer (BTB) access of the BTB of FIG. 1A.

FIG. 1C illustrates another example BTB access of the BTB of FIG. 1A.

FIG. 1D illustrates the increased instruction pipeline latency that may occur when flushing the pipeline of a conventional processor that includes a decoupled fetcher.

FIG. 2 illustrates an example aspect of the present disclosure where pipeline restart latency may be reduced.

FIG. 3 illustrates an example micro-architecture of a processing system according to aspects of the present disclosure.

FIG. 4 illustrates another example micro-architecture of a processing system according to aspects of the present disclosure.

FIG. 5A illustrates an example instruction unit tracking register and decoupled fetcher tracking register, according to aspects of the present disclosure.

FIG. 5B illustrates another example instruction unit tracking register and decoupled fetcher tracking register, according to aspects of the present disclosure.

FIG. 6A is a timing diagram illustrating instruction pipeline timing after a branch misprediction in a conventional decoupled fetching architecture.

FIG. 6B is a timing diagram illustrating instruction pipeline timing after a branch misprediction according to aspects of the present disclosure.

FIG. 7 illustrates an example process of restarting an instruction pipeline according to aspects of the present disclosure.

FIG. 8 illustrates an example process of restarting an instruction pipeline where the instruction unit has limited or no branch prediction capabilities, according to aspects of the present disclosure.

FIG. 9 illustrates an example process of restarting an instruction pipeline where the instruction unit has at least limited branch prediction capabilities, according to aspects of the present disclosure.

FIG. 10 illustrates an example device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects are directed to speeding up the restart of an instruction pipeline which follows the detection of a re-fetch event, such as a branch misprediction or a branch target buffer (BTB) miss. For example, in some aspects, to limit the impact of the increased redirection penalty, an instruction set architecture (ISA) may be implemented using a micro-architecture in which both the instruction unit (IU) and the decoupled fetcher (DCF) restart concurrently after a redirect signal (e.g., branch misprediction or miss in the DCF structures). That is, rather than have the IU wait for the DCF to generate fetch addresses, as it would in a regular pipelined architecture, both the IU and DCF may be restarted simultaneously. In one aspect, an advantage of such a micro-architecture may be that the additional pipeline restart latency may be hidden, improving performance.

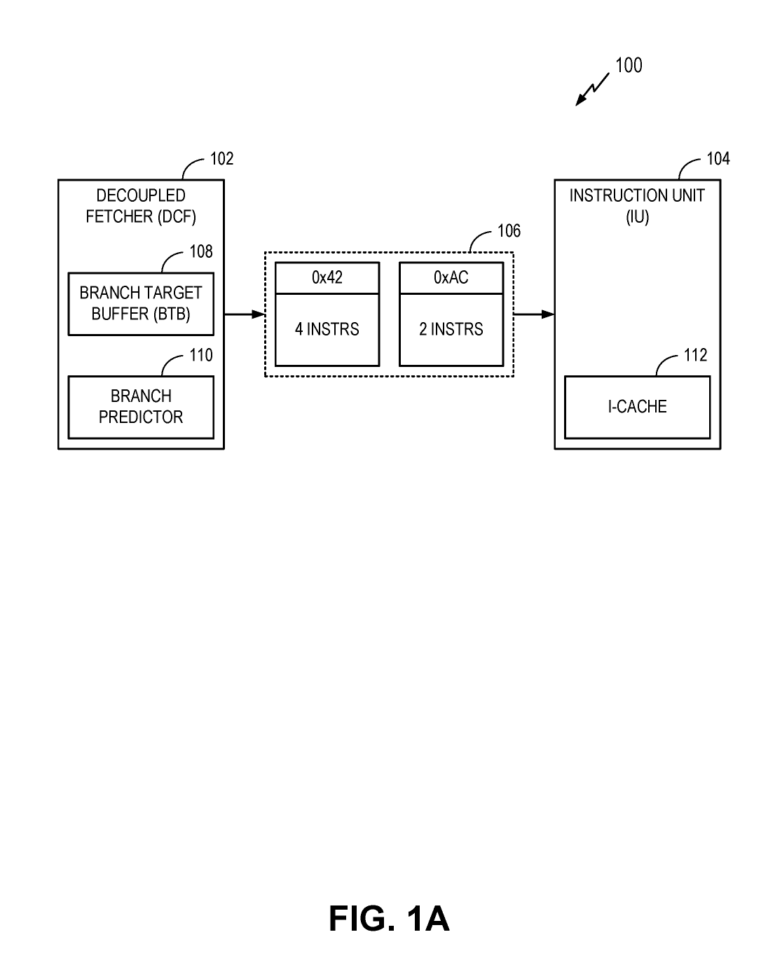

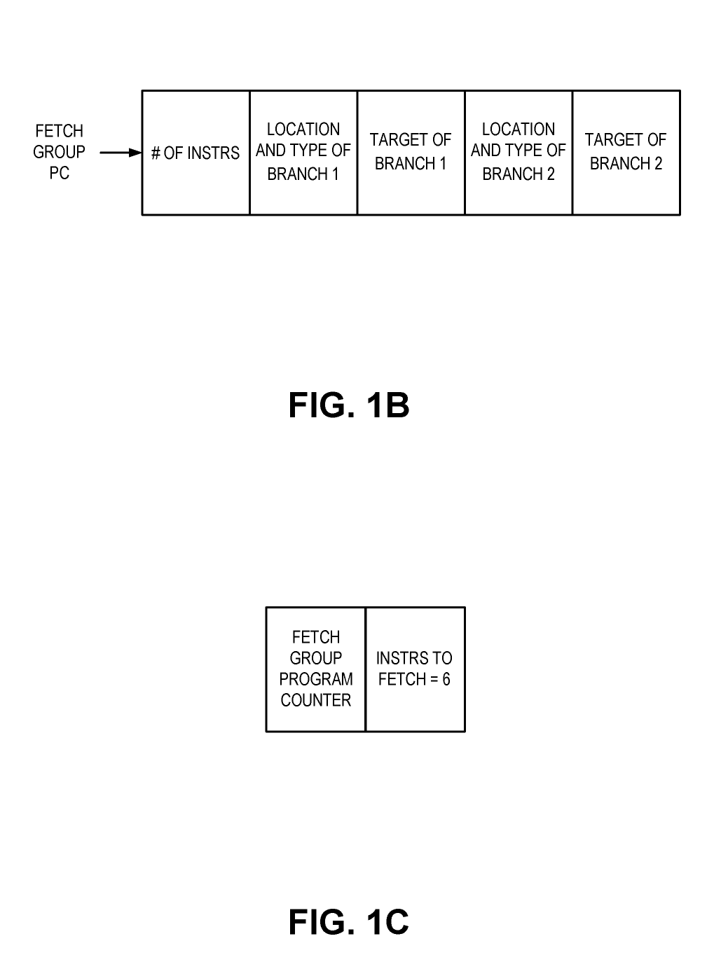

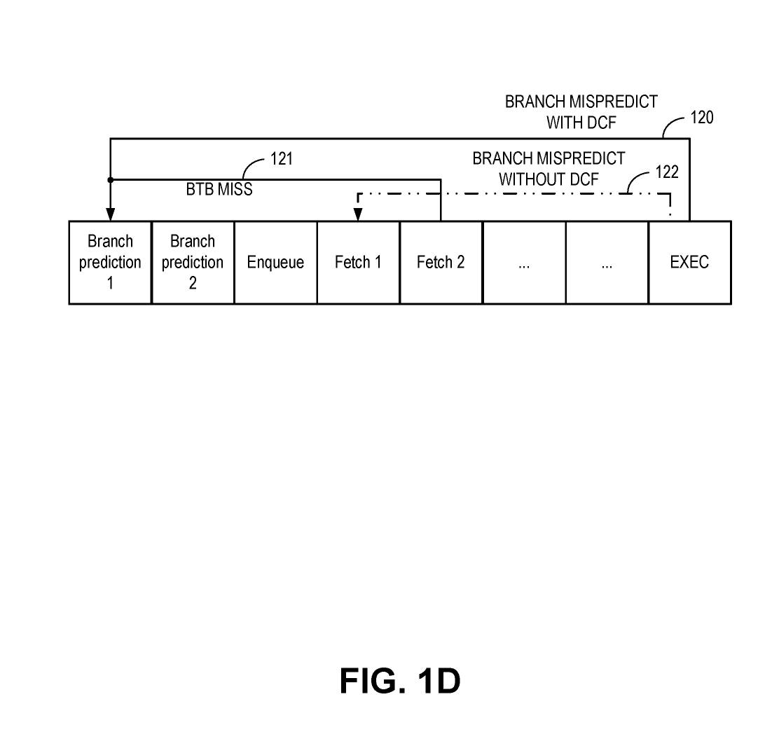

FIG. 1A illustrates a schematic of a micro-architecture 100 of a processing system that includes a conventional DCF 102. The micro-architecture 100 may be an implementation of an instruction set architecture (ISA). The illustrated example of the micro-architecture 100 includes the DCF 102, an instruction unit (IU) 104, and a fetch address queue (FAQ) 106 that includes an instruction stream of addresses. DCF 102 is shown as including a branch target buffer (BTB) 108 and a branch predictor 110. The IU 104 is shown as including an instruction cache (I-Cache) 112.

The inclusion of the DCF 102 separate from the IU 104 means that the operations of instruction fetching are decoupled from fetch address generation (including branch prediction). This allows fetch address generation (i.e., by DCF 102) to run-ahead and enqueue many future fetch addresses in the FAQ 106.

FIGS. 1B and 1C illustrate example branch target buffer (BTB) accesses of the BTB 108 of FIG. 1A. As shown in FIG. 1B, a block of instructions may include information related to the number of instructions, the location and type of a first branch instruction (e.g., Branch 1), the target of the first branch instruction, the location and type of a second branch instruction (e.g., Branch 2), and the target of the second branch instruction. FIG. 1C illustrates the block sent to the fetcher if the first branch instruction is predicted taken, assuming that the first branch instruction is the sixth instruction of this block. Continuing with this example, the next fetch group program counter will be the target of branch 1. The BTB 108 may enqueue blocks regardless of I-cache 112 misses.

However, as mentioned above, the lengthening of the pipeline due to the inclusion of DCF 102 increases the pipeline restart latency (e.g., after a branch misprediction) and also introduces a new potential flush source such as a BTB 108 miss. For example, in some cases, missing the BTB 108 may cause a flush if the missed block contains a branch instruction, whereas it may not trigger a flush if the missed block did not in fact have a branch. The increase in latency may be due to the fact that any fetch address must go through the address generation (e.g., DCF 102) stages before going through the IU 104 stages. This restart latency may be a contributor to performance degradation.

For example, FIG. 1D illustrates the increased instruction pipeline latency that may occur when flushing the pipeline of a conventional processor that includes a DCF 102. Line 120 illustrates the effect of a branch misprediction when utilizing DCF 102. When compared to the latency illustrated by line 122 of a branch misprediction without utilizing a DCF 102, the increased delay becomes apparent, for as described above, the IU 104 must wait for the address generation by the DCF 102 upon flushing. In addition, the inclusion of DCF 102 introduces a new trigger for flushing that may result from a BTB 108 miss, shown as additional delay line 121.

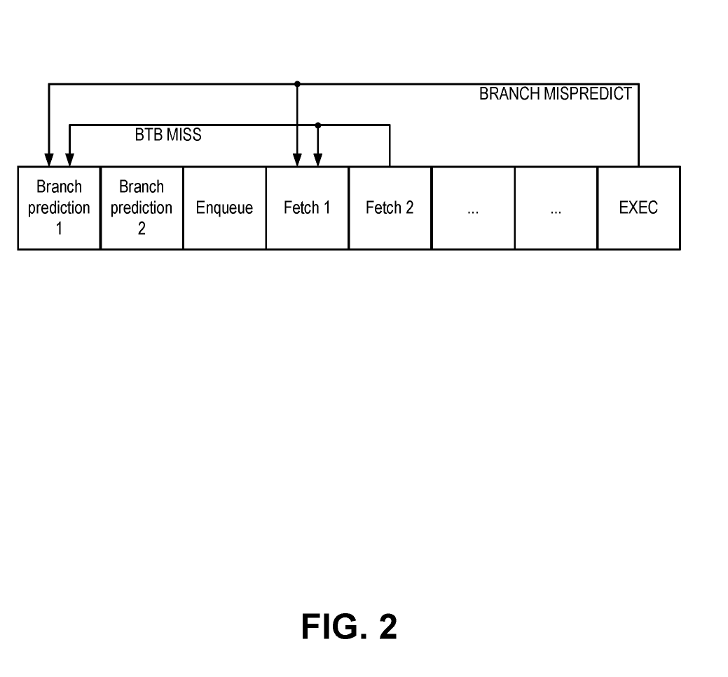

Accordingly, FIG. 2 illustrates an example aspect of the present disclosure where these additional pipeline restart latencies may be reduced. For example, as shown in FIG. 2, both a DCF and IU in accordance with aspects of the disclosure (as will be discussed in greater detail below) are restarted concurrently. That is, rather than having the IU wait for the DCF to generate fetch addresses, as was the case in FIG. 1D, aspects of the present disclosure allow for both the DCF and IU to be restarted at the same time. For example, as shown in FIG. 2, both the branch prediction 1 and the Fetch 1 are restarted in parallel. Thus, upon this restart, the next fetch program count (PC) is available such that the IU does not need for the DCF to generate it. In some aspects, this architecture may hide the additional latency that may occur due to decoupling and also may allow the early stages (e.g., DCF) to catch up while the actual fetch restarts.

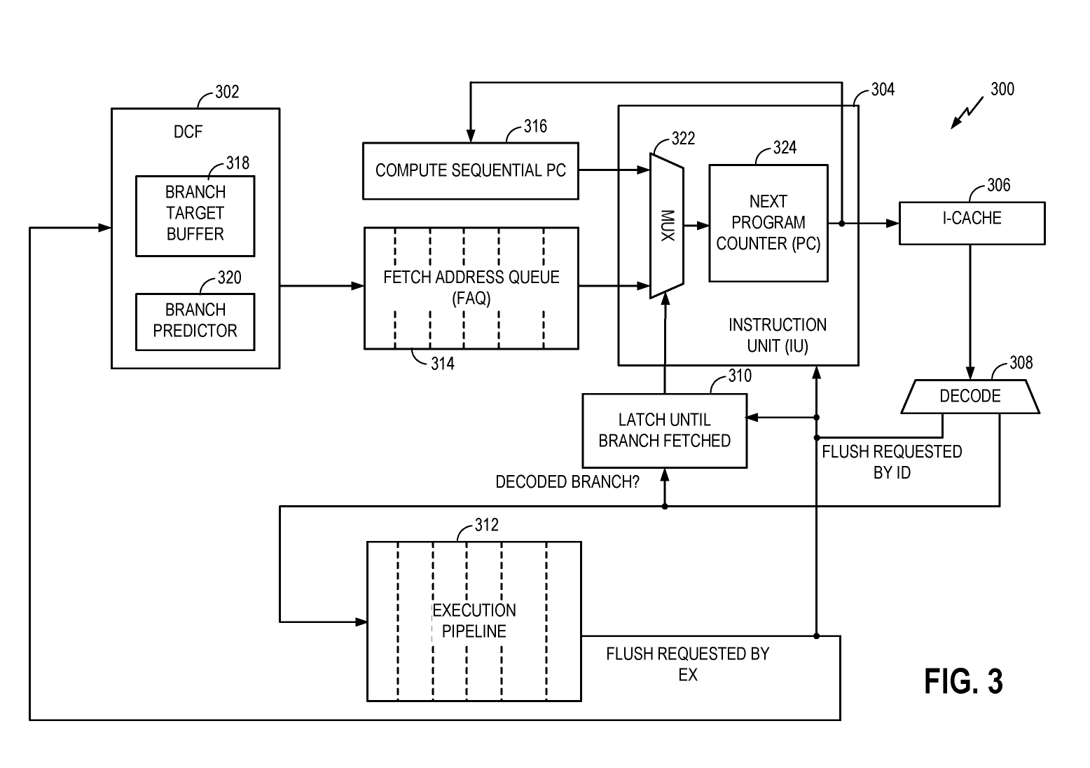

FIG. 3 illustrates an example micro-architecture 300 of a processing system according to aspects of the present disclosure. The illustrated example of micro-architecture 300 includes a DCF 302, an IU 304, an I-Cache 306, a decoder 308, a latch unit 310, an execution pipeline 312, a fetch address queue (FAQ) 314, and a sequential program counter (PC) 316. The illustrated DCF 302 is shown as including a branch target buffer (BTB) 318 and a branch predictor 320. IU 304 is shown as including a multiplexer (MUX) 322 and a next program counter (PC) 324. micro-architecture 300 is one possible architecture for implementing the pipeline restart described above with reference to FIG. 2.

In one aspect, the IU 304 has no branch prediction capability. Therefore, after a fast restart, the IU 304 is configured to wait for the DCF 302 as soon as it encounters a branch that must be predicted. That is, IU 304 may be configured to stop fetching at the first conditional or indirect branch, as IU 304 does not have prediction for what is the next PC. This may be sufficient to cover the additional restart latency due to decoupling instructions fetching from branch prediction.

In the illustrated example of FIG. 3, decoder 308 may be configured to trigger a pipeline flush (e.g., flush requested by instruction decoder (ID)). In one aspect, a pipeline flush means to remove all states from the stage that triggers the flush to the previous stages, i.e., subsequent stages are not flushed. Furthermore, in one aspect, the execution pipeline ‘IF’ is the IU 304 and “ID” is the decoder 308.

The MUX 322 gates where the IU 304 gets the address (PC) to drive the I-Cache 306. The MUX 322 inputs are information from the DCF 302 (IU 304 fed by DCF 302 in DCF mode), or the sequential PC of the last PC used to access the I-Cache 306 (IU 304 self-feed mode). The MUX 322 is driven by a latch unit 310 that is set when there is a flush request and reset when a branch goes out of the decoder 308. In some aspects, at that time, the IU 304 may have to scrub some of its state because of pipelining effects which amounts to killing inflight I-cache accesses (in case I-cache 306 is pipelined).

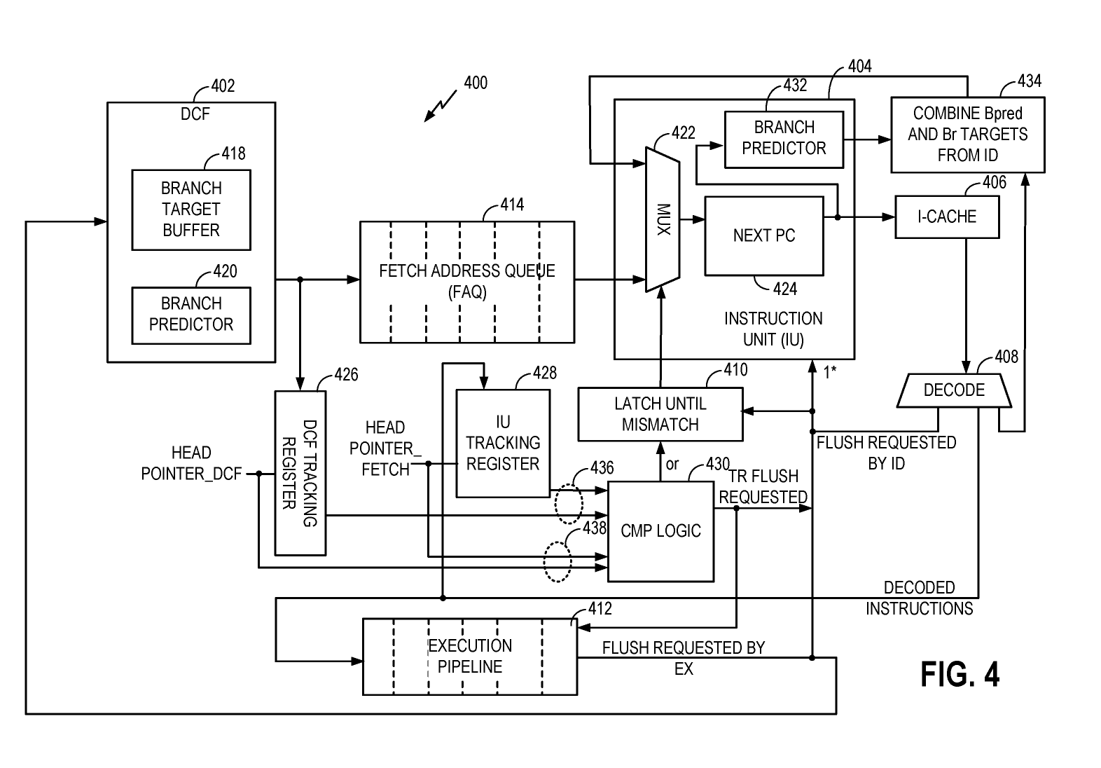

FIG. 4 illustrates another example micro-architecture 400 of a processing system according to aspects of the present disclosure. The illustrated example of micro-architecture 400 includes a DCF 402, an IU 404, an I-Cache 406, a decoder 408, a latch unit 410, an execution pipeline 412, a fetch address queue (FAQ) 414, a DCF tracking register 426, an IU tracking register 428, compare logic 430, and a combiner 434. The illustrated DCF 402 is shown as including a branch target buffer (BTB) 418 and a branch predictor 420. IU 404 is shown as including a multiplexer (MUX) 422, a next program counter (PC) 424, and a branch predictor 432. micro-architecture 400 is one possible architecture for implementing the pipeline restart described above with reference to FIG. 2.

In the micro-architecture 400, the IU 404 may include a simple branch prediction infrastructure (i.e., branch predictor 432), allowing IU 404 to continue fetching without waiting for predictions provided by the DCF 402. Thus, IU 404 may generate its own fetch PCs until the DCF 402 catches up after a restart. However, this means that the IU 404 and the DCF 402 can disagree, leading to divergence. Divergence is detected by comparing two bitvectors 436 (one for the DCF 402 by way of DCF tracking register 426 and one for the IU by way of IU tracking register 428) tracking taken branches. Any mismatch triggers a partial flush to remove instructions fetched by the IU 404 that are not on the path suggested by the DCF 402. Restarting from this flush is fast as the DCF 402 already has correct fetch addresses enqueued in the decoupling queue (i.e., FAQ 414). To resynchronize, the two bitvectors 436 are maintained by way of tracking registers 426 and 428, whereas backpressure stalls the fetching by IU 404, the bitvectors 436 will line up and decoupled fetching may then be resumed.

The operation of micro-architecture 400 is similar to micro-architecture 300 described above, in that IU 404 may operate in either a self-feed mode or in a DCF mode. However, in the self-feed mode of the IU 404, the next PC 424 is generated using the branch predictor 432 and branch targets coming out of the decoder 408.

In response to detecting a re-fetch event, a trigger is generated to simultaneously flush both the DCF 402 and the IU 404. At flush time, the two head pointers 438 (head pointer_DCF and head pointer_FETCH) get reset to point to the top of the respective tracking vectors (not shown in FIG. 4). When the DCF 402 enqueues a block in the FAQ 414 (or when a block is dequeued from the FAQ 414), information is pushed in the DCF tracking register 426. Similarly, when instructions are decoded, information is pushed in the IU tracking register 428. Using the head pointers 438 and the bitvectors 436, resync or mismatch is computed by way of compare logic 430. As shown in FIG. 4, compare logic 430 is coupled to receive the head pointers 438 and their respective corresponding bitvectors 436. If a mismatch is detected, the diverging instruction is located in the execution pipeline 412, and all younger instructions are flushed up to the IU 404.

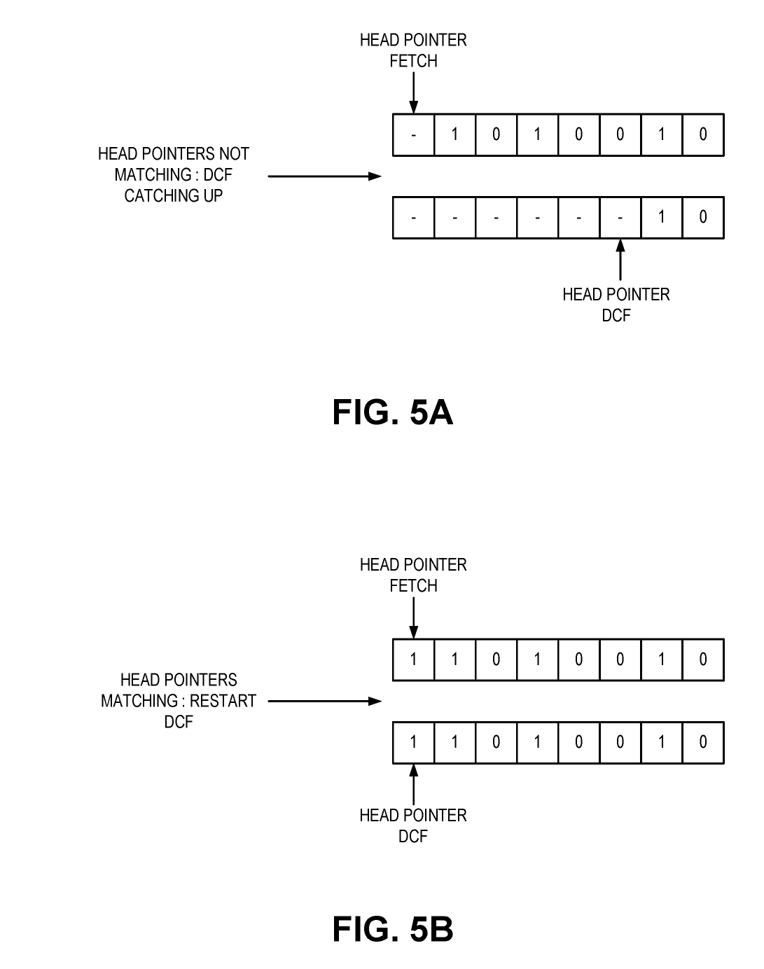

FIGS. 5A and 5B illustrate an example IU tracking register and DCF tracking register, according to aspects of the present disclosure. For example, FIG. 5A illustrates a mismatch that is detected between the IU tracking register 428 and the DCF tracking register 426. This mismatch indicates that the DCF 402 and the IU 404 did not follow the same path. Accordingly, in one aspect the micro-architecture 400 may be configured to assume that the IU 404 is correct and thus flush the DCF 402 state. In another example, the micro-architecture 400 may be configured to assume that the DCF 402 is correct and thus flush the execution pipeline 412 from the divergence point. FIG. 5B illustrates a match between the bitvector contained in IU tracking register 428 and the DCF tracking register 426. As described above, backpressure may stall the fetching by IU 404, such that the bitvectors of the two registers match such that IU 404 may re-enter the DCF mode so that decoupled fetching may be resumed.

In some aspects, micro-architecture 400 may include two additional queues (not shown in FIG. 4). The two additional queues may be similar to the two bitvectors maintained in tracking registers 426 and 428, where they relate to the predicted targets of indirect branches. One of the additional queues may be for the DCF and the other for the fetcher of IU 404. They are managed similarly to the bitvectors, with a head pointer for each. In one aspect, the additional queues are only used to detect divergence between the fetcher and the DCF (i.e., they do not play any role in resynchronizing the DCF and the fetcher). These additional queues may be relatively small since only the targets of indirects are needed to be pushed, which are less frequent than conditional branches. In some aspects, the two additional queues are included in the micro-architecture 400 if the branch predictor 432 of IU 404 is configured to predict indirect branches.

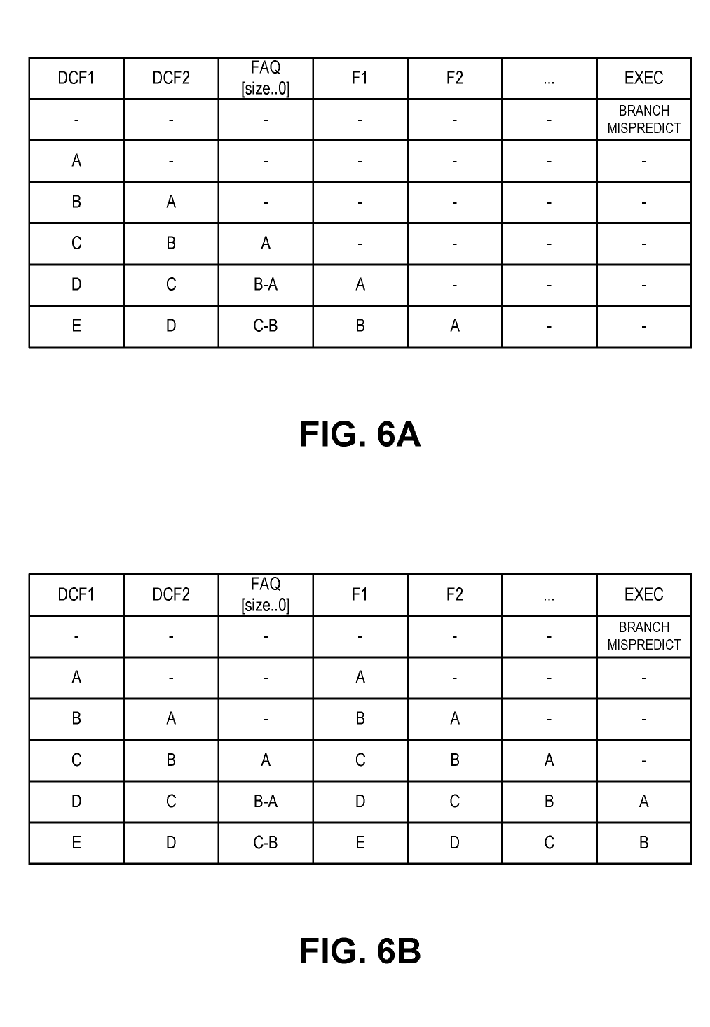

FIG. 6A is a timing diagram illustrating instruction pipeline timing after a branch misprediction in a conventional decoupled fetching architecture (e.g., micro-architecture 100 of FIG. 1A). As shown in FIG. 6A, after a branch misprediction, fetch address A has to go through the DCF stages before the I-cache can be accessed with it in Fetch 1.

FIG. 6B is a timing diagram illustrating instruction pipeline timing after a branch misprediction according to aspects of the present disclosure. The timing diagram of FIG. 6B may correspond to the instruction pipeline timing after a branch misprediction encountered by micro-architecture 300 of FIG. 3 and/or micro-architecture 400 of FIG. 4. As shown in FIG. 6B, the I-Cache is immediately accessed with fetch address A while the DCF catches up.

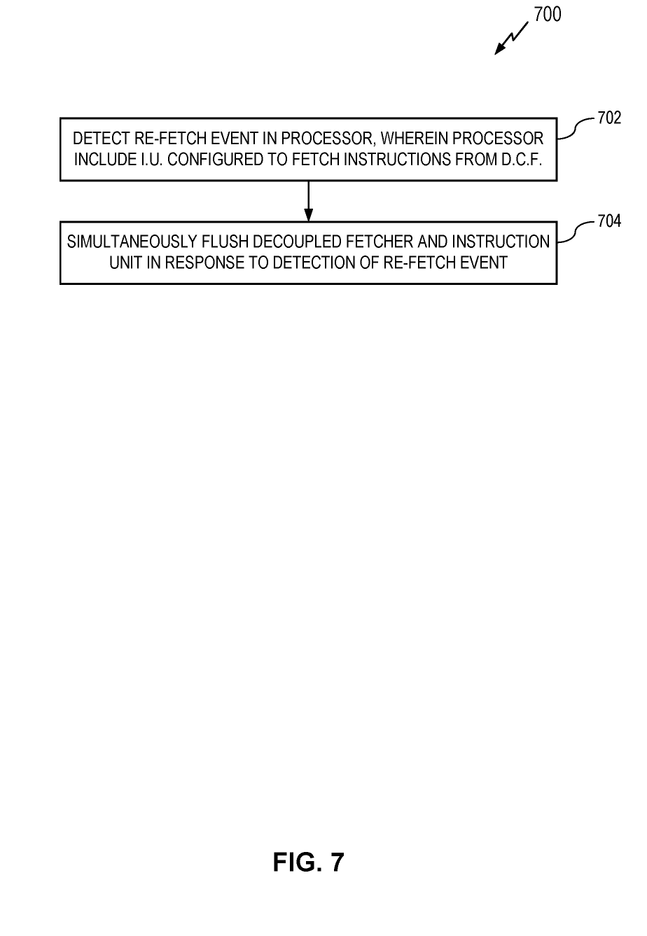

FIG. 7 illustrates an example process 700 of restarting an instruction pipeline according to aspects of the present disclosure. Process 700 is one possible process performed by the micro-architecture 300 of FIG. 3 and/or micro-architecture 400 of FIG. 4. In a process block 702, a re-fetch event is detected. As described above, a re-fetch event may include a branch misprediction and/or a BTB miss (e.g., BTB 318 of FIG. 3 or BTB 418 of FIG. 4). Furthermore a re-fetch event may be triggered by the decoder 408 of micro-architecture 400. Next, in process block 704, the DCF and the IU are simultaneously flushed in response to detecting the re-fetch event. That is, in one example, simultaneously flushing the DCF and the IU means rather than having the IU wait for the DCF to generate fetch addresses before flushing, as it would in a regular pipelined architecture, both the IU and DCF may be restarted simultaneously.

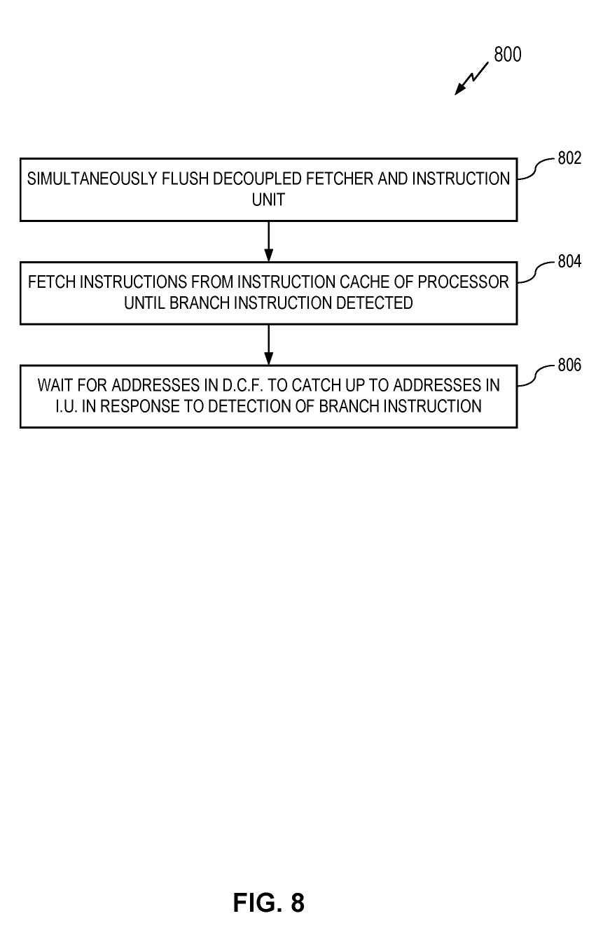

FIG. 8 illustrates an example process 800 of restarting an instruction pipeline where the IU has limited or no branch prediction capabilities, according to aspects of the present disclosure. Process 800 is one possible process of restarting an instruction pipeline performed by micro-architecture 300 of FIG. 3. In a process block 802, both the DCF 302 and the IU 304 are simultaneously flushed. In a process block 804, the IU 304 enters the self-feed mode where IU 304 fetches instructions from I-Cache 306 until a branch instruction is detected. As shown in FIG. 3, this may be accomplished by way of latch unit 310, which controls the MUX 322 to select where the IU 304 gets the address (PC) to drive the I-Cache 306 width.

Returning now to FIG. 8, in a process block 806, if the branch instruction is detected, the fetcher waits for the DCF 302 to catch up. That is, the IU 304 may cease fetching instructions from I-Cache 306 until address generation by the DCF 302 is caught up to the detected branch instruction. In response to the DCF 302 catching up, the IU 304 may return to the DCF mode where instructions are again fetched from DCF 302.

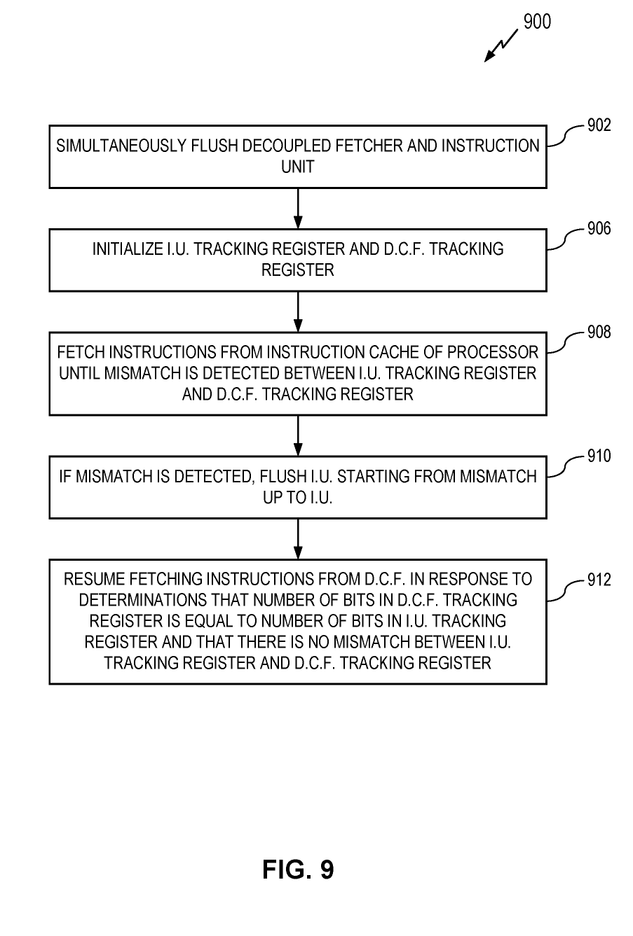

FIG. 9 illustrates an example process 900 of restarting an instruction pipeline where the IU has at least limited branch prediction capabilities, according to aspects of the present disclosure. Process 900 is one possible process of restarting an instruction pipeline performed by micro-architecture 400 of FIG. 4.

In a process block 902, both the DCF 402 and the IU 404 are simultaneously flushed. In a process block 906, the tracking vectors are initialized. In one aspect, initializing the tracking vectors may include resetting the bits in DCF tracking register 426 and in IU tracking register 428. Next, in a process block 908, the IU 404 enters the self-feed mode where IU 304 fetches instructions, including branch prediction, from I-Cache 406. In one aspect, the IU 404 continues fetching instructions in the self-feed mode until a tracking vector mismatch is detected (e.g., see mismatch illustrated in FIG. 5A). As shown in process block 910, if a mismatch is detected then the IU 404 may be flushed started from the divergence up to the IU (and where DCF 402 is not flushed). As shown in FIG. 4, this may be accomplished by way of latch unit 410, which controls the MUX 422 to select where the IU 404 gets the address (PC) to drive the I-Cache 406. In a process block 912, the IU 404 may return to the DCF mode where fetching from DCF 402 resumes. In one aspect, the return to the DCF mode may be made in response to the number of bits in the DCF tracking register 426 equaling the number of bits in the IU tracking register 428 and if there is no mismatch between the two bitvectors.

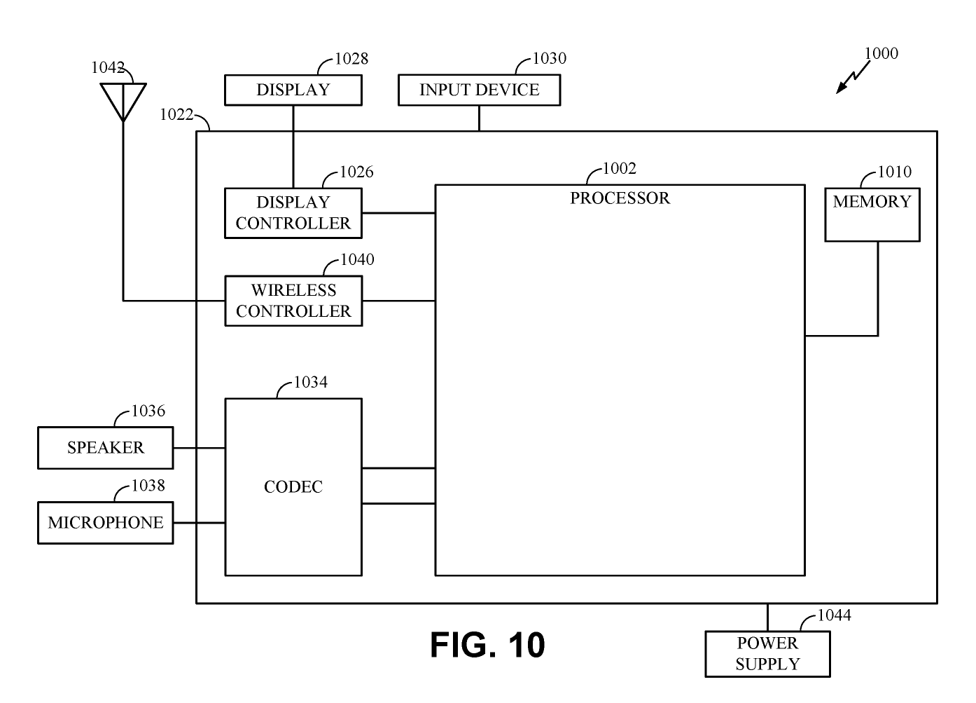

FIG. 10 illustrates an example device 1000 in which an aspect of the disclosure may be advantageously employed. For example, device 1000 includes a processor 1002 that may include the micro-architecture 300 of FIG. 3A and/or the micro-architecture 400 of FIG. 4, as discussed above. Processor 1002 may be communicatively coupled to memory 1010. I-cache is not explicitly shown in this view but may be part of processor 1002 or may be a separate block coupled between processor 1002 and memory 1010 as known in the art.

FIG. 10 also shows display controller 1026 that is coupled to processor 1002 and to display 1028. Coder/decoder (CODEC) 1034 (e.g., an audio and/or voice CODEC) can be coupled to processor 1002. Other components, such as wireless controller 1040 (which may include a modem) are also illustrated. Speaker 1036 and microphone 1038 can be coupled to CODEC 1034. FIG. 10 also indicates that wireless controller 1040 can be coupled to wireless antenna 1042. In a particular aspect, processor 1002, display controller 1026, memory 1010, CODEC 1034, and wireless controller 1040 are included in a system-in-package or system-on-chip (SoC) device 1022.

In a particular aspect, input device 1030 and power supply 1044 are coupled to the SoC device 1022. Moreover, in a particular aspect, as illustrated in FIG. 10, display 1028, input device 1030, speaker 1036, microphone 1038, wireless antenna 1042, and power supply 1044 are external to the SoC device 1022. However, each of display 1028, input device 1030, speaker 1036, microphone 1038, wireless antenna 1042, and power supply 1044 can be coupled to a component of the SoC device 1022, such as an interface or a controller.

In some aspects, the SoC device 1022 is a wireless communications device. However, in other aspects, processor 1002 and memory 1010 may also be integrated into a set-top box, a music player, a video player, an entertainment unit, a navigation device, a personal digital assistant (PDA), a fixed location data unit, a computer, a laptop, a tablet, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Thus, a computing device may include several components that may be employed according to various aspects of the present disclosure. Such a computing device may include modules that incorporate any of the aforementioned instruction set architectures, such as micro-architecture 300 of FIG. 3 and/or micro-architecture 400 of FIG. 4.

For example, a first module may be for detecting a re-fetch event in a processor such as processor 1002 of FIG. 10. The first module may correspond, at least in some aspects, to execution pipeline 312 and decoder 308 of FIG. 3, and/or execution pipeline 412 and decoder 408 of FIG. 4. A second module may be for simultaneously flushing the DCF and the IU in response to detecting the re-fetch event. The functionality of these modules may be implemented in various ways consistent with the teachings herein. In some designs, the functionality of modules may be implemented as one or more electrical components. In some designs, the functionality of the modules may be implemented as a processing system including one or more processor components. In some designs, the functionality of the modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module. In addition, the components and functions represented by the aforementioned modules, as well as other components and functions described herein, may be implemented using any suitable means. Such means also may be implemented, at least in part, using corresponding structure as taught herein. For example, the components described above in conjunction with the “module” components may correspond to similarly designated “means for” functionality. Thus, in some aspects, one or more of such means may be implemented using one or more of processor components, integrated circuits, or other suitable structure as taught herein.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for restart of an instruction pipeline. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method, wherein the method comprises:
detecting, in a processor, a re-fetch event, wherein the processor includes an instruction unit (IU) configured to fetch instructions from a decoupled fetcher (DCF); and
simultaneously flushing the IU and the DCF in response to detecting of the re-fetch event.

2. The method of claim 1, wherein detecting the re-fetch event comprises:
detecting a branch misprediction;
detecting a branch target buffer miss; or
any combination thereof.

3. The method of claim 1, further comprising:
fetching, by the IU, instructions from an instruction cache of the processor in response to the simultaneous flushing of the DCF and the IU.

4. The method of claim 3, further comprising:
detecting a branch instruction; and
stopping the fetching of the instructions in response to the detection of the branch instruction.

5. The method of claim 4, further comprising:
determining whether addresses in the DCF have caught up to addresses in the IU in response to the detection of the branch instruction; and
resuming fetching of the instructions from the instruction cache in response to a determination that the addresses in the DCF have caught up to the addresses in the IU.

6. The method of claim 1, further comprising:
initializing an IU tracking register;
initializing a DCF tracking register; and
fetching instructions from an instruction cache of the processor until a mismatch is detected between the IU tracking register and the DCF tracking register.

7. The method of claim 6, wherein the fetching instructions from the instruction cache includes performing branch predictions by the IU.

8. The method of claim 6, further comprising:
detecting the mismatch between the IU tracking register and the DCF tracking register; and
flushing the IU beginning from the mismatch up to the IU in response to the detecting of the mismatch.

9. The method of claim 8, wherein flushing the IU includes preventing flushing of the DCF while the IU is flushed.

10. The method of claim 8, further comprising:
determining that a number of bits in the DCF tracking register is equal to a number of bits in the IU tracking register;
determining that there is no mismatch between the IU tracking register and the DCF tracking register; and
resuming the fetching of instructions from the DCF in response to determinations that the number of bits in the DCF tracking register is equal to the number of bits in the IU tracking register and that there is no mismatch between the IU tracking register and the DCF tracking register.

11. An apparatus, wherein the apparatus comprises a processor that includes an instruction unit (IU) configured to fetch instruction from a decoupled fetcher (DCF), wherein the processor is configured to:
detect a re-fetch event; and
simultaneously flush the DCF and the IU in response to detecting of the re-fetch event.

12. The apparatus of claim 11, wherein to detect the re-fetch event, the processor is further configured to:
detect a branch misprediction;
detect a branch target buffer miss; or
any combination thereof.

13. The apparatus of claim 11, wherein the IU is further configured to fetch instructions from an instruction cache of the processor in response to the simultaneous flushing of the DCF and the IU.

14. The apparatus of claim 13, wherein the processor is further configured to:
detect a branch instruction; and
stop the fetching of the instructions in response to the detection of the branch instruction.

15. The apparatus of claim 14, wherein the processor is further configured to:
determine whether addresses in the DCF have caught up to addresses in the IU in response to the detection of the branch instruction; and
resume fetching of the instructions from the instruction cache in response to a determination that the addresses in the DCF have caught up to the addresses in the IU.

16. The apparatus of claim 11, wherein the processor is further configured to:
initialize an IU tracking register;
initialize a DCF tracking register; and
fetch instructions from an instruction cache of the processor until a mismatch is detected between the IU tracking register and the DCF tracking register.

17. The apparatus of claim 16, wherein to fetch the instructions from the instruction cache, the IU is further configured to perform branch predictions.

18. The apparatus of claim 16, wherein the processor is further configured to:
detect the mismatch between the IU tracking register and the DCF tracking register; and
flush the IU beginning from the mismatch up to the IU in response to the detecting of the mismatch.

19. The apparatus of claim 18, wherein to flush the IU, the processor is further configured to prevent flushing of the DCF while the IU is flushed.

20. The apparatus of claim 18, wherein the processor is further configured to:
determine that a number of bits in the DCF tracking register is equal to a number of bits in the IU tracking register;
determine that there is no mismatch between the IU tracking register and the DCF tracking register; and
resume the fetching of instructions from the DCF in response to determinations that the number of bits in the DCF tracking register is equal to the number of bits in the IU tracking register and that there is no mismatch between the IU tracking register and the DCF tracking register.

21. An apparatus, the apparatus comprising:
means for detecting a re-fetch event; and
means for simultaneously flushing an instruction unit (IU) and a decoupled fetcher (DCF) in response to detecting of the re-fetch event.

22. The apparatus of claim 21, wherein the means for detecting the re-fetch event comprises:
means for detecting a branch misprediction;
means for detecting a branch target buffer miss; or
any combination thereof.

23. The apparatus of claim 21, further comprising:
means for fetching instructions from an instruction cache in response to the simultaneous flushing of the DCF and the IU.

24. The apparatus of claim 21, further comprising:
means for initializing an IU tracking register;
means for initializing a DCF tracking register; and
means for fetching instructions from an instruction cache until a mismatch is detected between the IU tracking register and the DCF tracking register.

25. The apparatus of claim 24, wherein the means for fetching instructions from the instruction cache comprises:
means for performing branch predictions.

26. A non-transitory computer-readable medium comprising at least one instruction for causing a processor to perform operations, comprising:
code for detecting a re-fetch event; and
code for simultaneously flushing an instruction unit (IU) and a decoupled fetcher (DCF) in response to detecting of the re-fetch event.

27. The non-transitory computer-readable medium of claim 26, wherein the code for detecting the re-fetch event comprises:
code for detecting a branch misprediction;
code for detecting a branch target buffer miss; or
any combination thereof.

28. The non-transitory computer-readable medium of claim 26, further comprising:
code for fetching instructions from an instruction cache in response to the simultaneous flushing of the DCF and the IU.

29. The non-transitory computer-readable medium of claim 26, further comprising:
code for initializing an IU tracking register;
code for initializing a DCF tracking register; and
code for fetching instructions from an instruction cache until a mismatch is detected between the IU tracking register and the DCF tracking register.

30. The non-transitory computer-readable medium of claim 29, wherein the code for fetching instructions from the instruction cache comprises:
code for performing branch predictions.
